(19) United States
(12) Patent Application Publication
(10) Pub. No.: US 2006/0229950 A1
(43) Pub. Date: Oct. 12, 2006

(54) An efficient method of discovering and purchasing goods and services

(76) Inventors: Nagesh Pabbisetty, Redmond, WA (US); Peter Sirota, Seattle, WA (US)

Correspondence Address: Peter;Sirota, 210 Wall Street, Apt 203, Seattle, WA, 98121, US

(21) Appl. No.: 10/907,646

(22) Filed: Apr. 10, 2005

(51) Int. Cl. G06Q 30/00

(52) U.S. Cl. 705/26

(57) ABSTRACT

This invention includes a process, method, and system for discovering goods and service at user-specified criteria and executing purchase orders on behalf of customers. In various embodiments, users can search and register interest in various items while the system continuously searches for the best deals matching the users search criteria and providing various methods for notification, purchase and fulfillment for requested items.

### BACKGROUND

The Internet allows for rapid and continuous data exchange between people and systems in different geographic locations. The Internet has become a valuable market place where goods and services are discovered, bought and sold. Most people have become comfortable augmenting their offline shopping with online shopping; both offline and online commerce are growing rapidly. The rapid adoption of mobile phones with advanced capabilities allows people to stay connected with both people and services separated by time and space. People's lives have gotten busier; they want to enhance the “fun” and “thrill-of-the-hunt” in the shopping experience in parallel with increasing the effectiveness and efficiency of the purchase experience. They want to buy the right product at the right price at the right time from the right vendor.

It is often cumbersome to discover and purchase products and services on the Internet. For example, when an individual intends to purchase an item, the item may not be available or the price of the item may not be acceptable for the individual; the only option the user has is to keep checking periodically. Sometimes, the user may be willing to wait to get the best deal on the product of choice or a similar product but the user has no easy way to do that today. The online shopping experience to find the right product at the right price has been elusive. Additionally, once the item is discovered and a decision to purchase an item is made, online vendor selection process could become difficult and confusing for customer. This may result in, among other things, purchasing items at prices higher than necessary as well as poor purchasing experience from vendors the user may not care for.

Shopping in the off-line world has benefited immensely from the vast amount of information available in the online world; car buyers go into the stores armed with the exact configuration they want and the price they want to pay. However, in the retail buying experience for everyday goods and services, the user has no easy way of comparing prices among online and offline deals, watching for the right price, or knowing the best deal the user could get from an alternate store. The advent of advanced mobile phones and connectivity can help users make the right shopping decision.

### SUMMARY OF INVENTION

According to an aspect of the invention, a method includes discovering goods and services (“items”), registering interest in items matching a set of search criteria (“orders”) such as the purchase price, dispatching a notification when items matching a specific set of criteria are found and providing easy ways to complete the purchase.

Another aspect of the invention includes a method for registering items at specific prices along with other relevant attributes/constraints (“deals”), soliciting deals from third parties, harvesting deals from sites and other third-party sources, aggregating orders and negotiating with vendors to drive the price down or relax other constraints/restrictions.

A method for discovering an item may include search on the Internet or at a physical location. The search can be specified in a web browser interface by typing detailed item description or an item code such as UPC, ISBN, ASBN or other code, or by using a bar code reader or other device to scan or record a code or any identifiable information.

A method for registering interest in an item may include one or more of the following: a specific item (may be identified by name or reference code or brand, or others), a category or item classification, a price or a price range, a vendor name or list of vendors, a payment method, a deal alert notification method, and a delivery method for the item. The method may include registering an item for price search. The price range or a specific price can be configured for each item. Alternatively, a method may include searching for a category of items at specified price ranges and other criteria. The user could indicate preferences for items such as brand, store name or vendor, or ratings for the products/services/vendors, or others. Alternatively, the registration method could import, either on a one-time or on a continuous basis, existing lists such as wish lists, shopping carts, and others. The registration method could also import highlighted text from an electronic document, or on a hard-copy captured into electronic form by a device such as a scanner or camera or others.

A method for importing deals may include harvesting other sites on the web that would list deals. The method may also include capability of registering a deal by customers or third parties who found deals via alternate methods. All deals could be registered in a deal repository which can be accessed by the deal-search method, or any other method or by a human. An alternative method may include soliciting third parties for deals that may or may not be prompted by the item-registration method.

A method for deal negotiation may include direct deal negotiations for popular or close-out items or others to obtain the best deals for users. This may involve bidding and counter-bidding process either manually or electronically executed resulting in a deal marketplace.

A method for deal search may include polling the deal repository for the best match. Alternatively, a process could, on an ongoing basis, solicit vendors to submit their bids for items and/or categories that match the specified criteria.

A method for deal alert notification may include reminding or alerting the user when the item that matches the search criteria, for example price, is found. Users may be alerted by sending a notification such as email or a message to a device, or generating a pop-up alert on the customer's device such as computer or phone or other device. The alert may be configured with specific frequency for example once a day, or triggered as soon as deals matching the search criteria are found. An alternative implementation may involve providing streaming of deals continuously to the customer's computer or another device.

An alternate implementation of accessing the deals closest to or satisfying the search criteria could be to allow a user to use a browser or portable device to access this information. It is not always necessary that the customer has to wait for the notification to find out what is the best deal on items that match the customer's selection criteria.

The purchasing method may include purchasing the specified item automatically on behalf of the customer or providing various purchasing options in the alert. The purchasing options may include a purchasing link that would trigger the system to purchase the item on behalf of the customer. Another implementation could connect the customer with a customer service representative when the customer clicks the purchasing link sent to him so as to place the order or find more information.

The above-described processes may also be implemented as a sequence of instructions executed by a processor.

The invention could provide one or more of the following advantages. An item with acceptable search criteria such as price may be discovered. A process may search for the item continuously until an acceptable deal is found. At automatic notification can occur when the deal is found. Further, a purchase of an item may be instantiated on behalf of the customer. The item may be delivered by the vendor to the customer.

Additionally, the invention provides ability to advertise targeted deals to users interested in specific items. A process may be established to aggregate requests and solicit deals from vendors to drive discounts. The business intelligence data on reliability of vendors, popular items, acceptable price points and other information could be aggregated and provided to various parties for continuous improvement of the shopping experience.

Overall, the above methods increase the efficiency and effectiveness of the discovery and purchase process.

Below, there is a description of a method and apparatus for discovering and purchasing goods and services. While the present invention has been described in terms of the illustrated embodiments below, those skilled in the art will recognize that the invention is not limited to the embodiments described. The present invention can be practiced with the modification and alteration within the spirit and scope of the included claims. Thus, the description is to be regarded to be illustrative instead of being restrictive.

### DESCRIPTION OF DRAWINGS

For a particular embodiment of the invention, the following figures show the salient elements of the invention.

FIG. 1 is a block diagram depicting a communication network for registering items and searching for deals;

FIG. 2 is a block diagram of an Item Registration process;

FIG. 3 is a component configuration screen rendered by the Item Registration process;

FIG. 4 is a block diagram of a Deal Search process and Alert Notification process;

FIG. 5 is a block diagram of the Item Purchasing process;

FIG. 6 is a block diagram of Deal Import process;

FIG. 7 is a block diagram of the Deal Marketplace;

### DETAILED DESCRIPTION

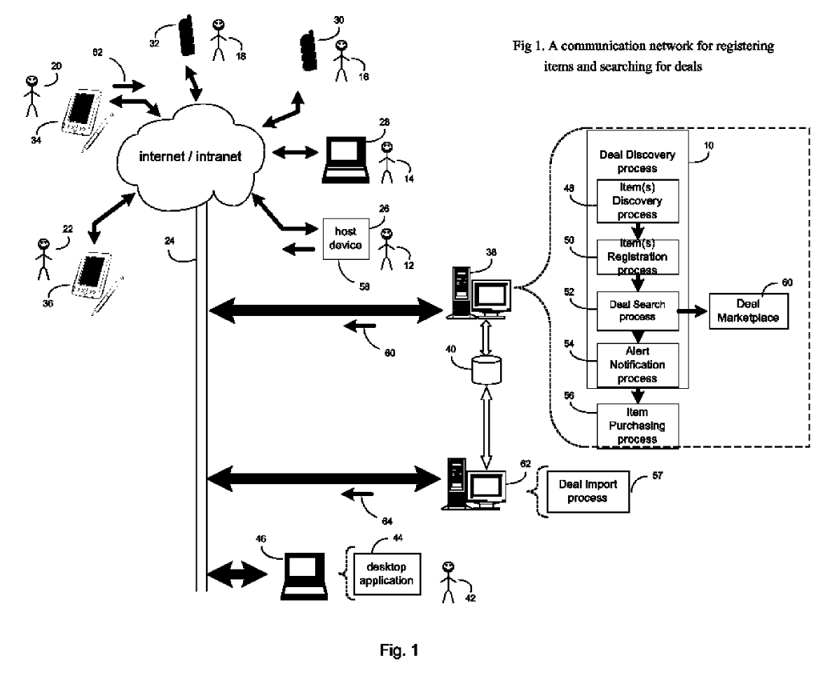

Please refer to FIG. 1. The Deal discovery process 10 includes four processes: an Item Discovery process 48, an Item Registration process 50, a Deal Search process 52 and an Alert Notification process 54. In addition, an Item Purchasing process 56 can be invoked to complete the purchase. Host 12 can import deals from various sources. Deal Import process 57 is used to continuously harvest deals from various websites and sources. Users discover items they are interested in using Item Discovery process 48. Once an item is discovered, users use the Item Registration process 50 to register interest in an item by providing the name of the item or category, an acceptable price or price range and other search criteria instructing the Deal Search process 52 to find a deal that best matches the specified criteria. Sometime after the Deal Search process 52 found the best match, an Alert Notification process 54 sends out an alert to the users and, around the time when the purchase is to be made, the Item Purchasing process 56 establishes the required connections and purchases the item on behalf of the user.

The Deal Import process 57 harvests deals from various sites on the Internet; these sites may include online deal aggregation sites, coupon aggregation sites, online stores of various vendors, and others. Alternatively, a host 12 can input items and deals such as coupons for products or services, sale and clearance prices, promotional prices and others. Host 12 typically participates in the Deal Import process using a host device 26, such as a computer, a telecommunication device, or others. These deals are stored in the Repository 40 and accessed by various other internal and external processes.

Customers 14, 16, 18, 20, and 22 using electronic devices that are connected via a distributed network 24 (e.g., the Internet, an intranet, a local area network, or some other form of network) can access the Deal Discovery process, Item purchasing process, and also input deals into the Repository 40 thru a user-interface. Further, customers 14, 16, 18, 20, and 22 typically participate in the Deal Discovery process, Item Purchasing process, etc., via computers (e.g., computers 28), telecommunication devices (e.g., cell phones 30 and 32) or handheld personal digital devices (e.g., personal digital assistants 34 and 36).

Deal Discovery process 10, Item Purchasing process 56, Deal Import process 57 and Deal Marketplace 60 typically reside on and are executed by a server or set of servers 38 that are connected to the network 24. The instruction sets and subroutines of these processes are typically stored on a storage device Repository 40 connected to server 38 or directly to network 24. Repository 40 may be, for example, a hard disk drive, a tape drive, an optical drive, a RAID array, a random access memory (RAM), or a read-only memory (ROM), or other.

An administrator 42 typically accesses and administers deal discovery process 10 through a desktop application 44 (e.g., Microsoft Internet Explorer™, Netscape Navigator™, or a specialized interface, not shown) running on a computer 46 that is also connected to the network 24.

In order for the user to discover or identify a desired item he could use an internet browsing tool (e.g., a Microsoft Internet Explorer™), or other tool capable of searching and displaying items being presented by the computer systems 28, 30. If the user has access to a physical item for which he wants to find a deal, a user uses a hardware bar code reader or a digital camera or another device such as 34 to collect an identifying number or picture or other unique information from the item. In some arrangements, users can search for items using the search interface provided by the process 48. Some other arrangements may include searching alternative Internet sites (e.g., a Google™ or Amazon™) and collecting items using a browser plug-in which can interpret highlighted text or URLs of individual items and supply them to the Item Discovery process 48 or the Item Registration process 50.

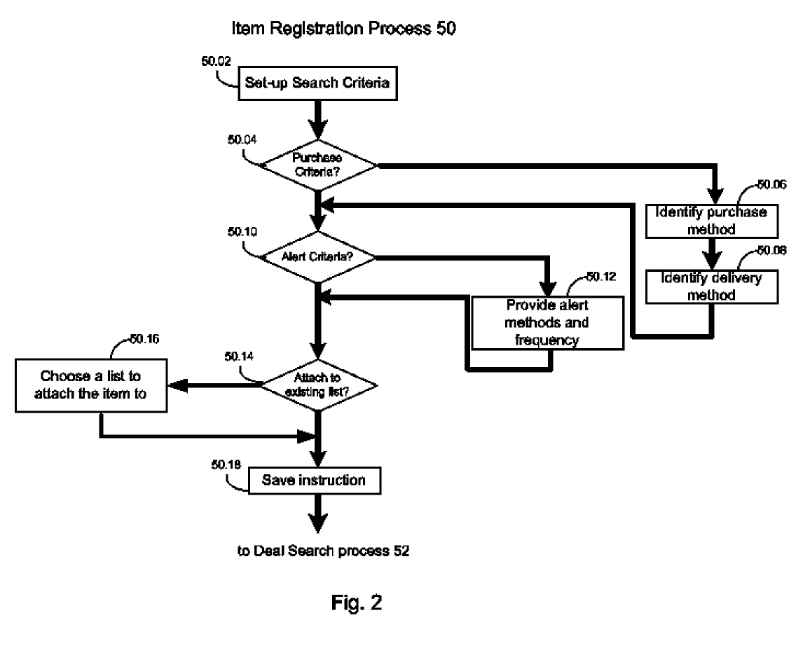

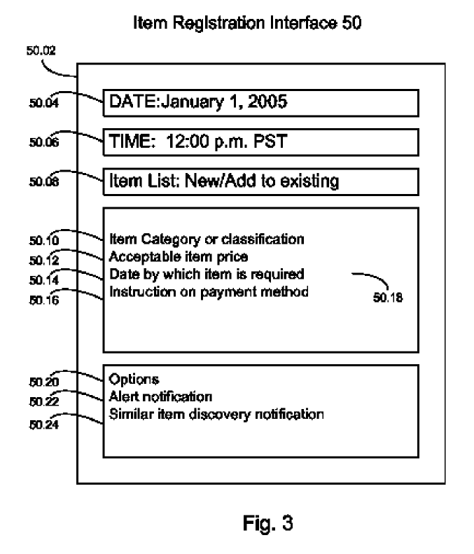

After the user has discovered a desired item, an Item Registration process 50 shown in FIG. 2 is used to record and submit details about the item, and other search attributes of interest. The Item Registration process 50 presents ability for the user to create a separate item to search for or to attach the desired item to an already existing list of items-searches as shown in FIG. 2. As shown in FIG. 3, the Item Registration process 50 records the day and time the deal search request was entered, item category and classification, item acceptable price or a price range, date by which the user wishes to receive the item, payment method instructions, alert notifications instructions, and other such information. Additionally, the Item Registration process may suggest alternative items that could be registered. Once received by the Item Registration process 50, the data and settings are transferred to the Repository 40.

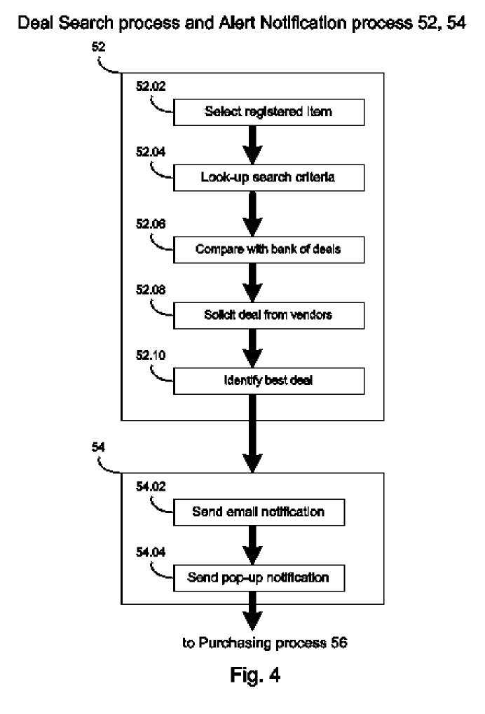

Referring to FIG. 4, the Deal Search process 52 determines the search criteria for each item registered by the Item Registration process in order to search for the best deals. A process 52.02 is used to make such determination. In some arrangements, the determination is made by monitoring the log file or a database table that includes a list of all requested items. If it is determined that the item is present in the table and the date of the request is within the range necessary for the process 52 to find the item, this process 52.02 hands off the item to process 52.04 as shown on the FIG. 4. The process 52.04 looks up the search criteria for the item that may include the desired price or a price range and other search criteria supplied during the Item Registration process. In case the item cannot be uniquely identified by process 52.02, process 52.04 identifies a category of items for which to search. Using the item or category identified by process 52.02 and the search criteria identified by process 52.04, process 52.06 looks in Repository 40 of valid deals to see if there is already a deal in the Repository 40 that satisfies the search criteria. In scenarios where a matching deal is not found, process 52.08 solicits deals from vendors by supplying the item description and/or search criteria. This process also updates the Repository 40 with the deals obtained. Process 52.10 identifies the best deal and/or the deal that best fits the criteria specified by the Item Registration process and provides the information to process 54.02. Process 52.02 and 52.04 review the Alert preferences supplied during the Item Registration process and send the appropriate Alert to the user.

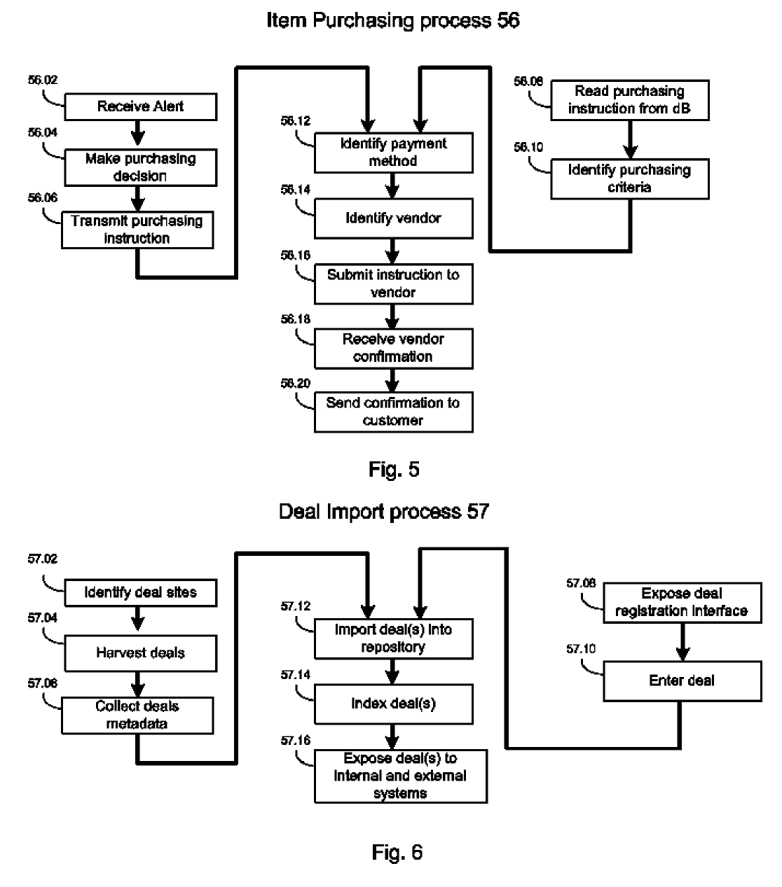

The Item Purchase process 56 is detailed in FIG. 5. An Item may be purchased automatically because that's what the user specified during Item Registration process. Process 56.08 reads the purchasing instructions collected during the Item Registration process and stored in Repository 40, and hands them to process 56.10 to check if the item is to be purchased automatically. If so, process 56.12 identifies the payment method while process 56.14 identifies the vendor based on vendor preferences and list of vendors specified in the deals identified by the Deal Search process. Process 56.16 submits the instructions identified by process 56.14 and works with the vendor to receive confirmation of receiving the order. Process 56.20 sends the confirmation to the user, per preferences indicated during the Item Registration process.

Alternatively, the purchase could be completed through manual intervention by the user within Item Purchase process 56. The user receives an alert from the Alert Notification Process in process 56.02. The user determines whether he wants to buy the product automatically in process 56.04. The user's purchase preferences are transmitted in process 56.06 to process 56.12. Process 56.12 and subsequent steps in the Item Purchase process 56 were described in the above paragraph.

The Deal Import process 57 is detailed in FIG. 6. Process 57.02 obtains a list of deal sites to harvest from Repository 40. Process 57.04 crawls and harvests the deal sites and provides the deals to process 57.06 which collects the meta-data for each deal. Process 57.12 adds the deal and the associated metadata into Repository 40. Process 57.14 indexes the deals to make it easier and faster to search for them in the Repository 40. Process 57.16 exposes access to deals in Repository 40 to other internal and external processes. Deals can also be entered into the Repository via a deal registration interface process 57.08. Deals are entered through this interface either manually or by an automaton via process 57.10. Deals entered via 57.10 are added to the repository as described by the sequence of steps starting with process 57.12, described above.

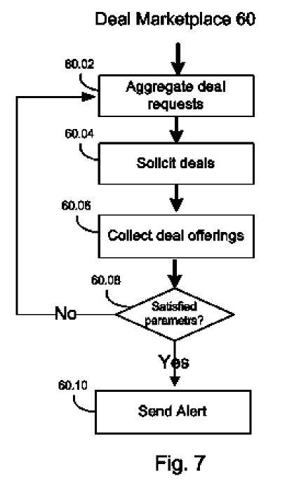

The Deal Marketplace process 60 is described in FIG. 7. This processes aggregates requests for Items across various users and negotiates volume discounts and special promotions on behalf of the users who registered items through the Item Registration process. When several identical or similar items are registered by the Item Registration process, process 60.02 aggregates requests. For each aggregated request, process 60.04 solicits deals from the vendors in the Repository 40; this solicitation and negotiation could be a manual or an automated/computerized process. Process 60.06 collects the deals from various vendors and registers the best deals available in the Repository 40. Process 60.08 checks to see if it satisfies the criteria that the users specified via the Item Registration process. If not, process 60.02 is invoked again to aggregate the deal requests and flow through the whole process in FIG. 7 again. The deal solicitation and negotiation continues on a periodic basis until deals that satisfy certain criteria are received.

### CONCLUSION AND EPILOG

Thus, it can be seen from the above description, a method and apparatus for discovering and purchasing goods and services has been described. While the present invention has been described in terms of the above-illustrated embodiments, those skilled in the art will recognize that the invention is not limited to the embodiments described. The present invention can be practiced with the modification and alteration within the spirit and scope of the appended claims. Thus, the description is to be regarded as illustrative instead of restrictive on the present invention.

What is claimed is:

1. In the Deal Discovery process, a method of operation comprising discovering an item AND registering interest in an item with specified search criteria.

2. The method of claim 1, wherein an item discovery includes defining an item description which could be used to uniquely identify an item.

3. The method of claim 2, wherein an item description comprises of an item unique code or item category or alternatively, text summarizing the item.

4. The method of claim 1, wherein the method of discovering an item comprises of querying various search engines and/or querying item repository and receiving said item or item variations or similar items.

5. The method of claim 4, wherein a method of querying comprises adaptively retrieving said items in a manner that is consistent with accuracy objective for receiving said items.

6. The method of claim 1, wherein the method of item discovery includes selecting an item from a list of items generated by any automaton such as a search engine and processing the selection to uniquely resolve into a unique identifier for the item.

7. The method of claim 1, wherein the method of item discovery includes importing preexisting list of items.

8. The method of claim 7, wherein the method of importing the item list includes taking the list from the identified source and copying it to herein described system such that the imported instance of the list can be modified without modifying the original source.

9. The method of claim 7, wherein the method of importing the item list includes linking the lists from the identified source to the herein described system such that any changes to the list from the original source will dynamically change the instance of this list in herein described system and vice versa.

10. The method of claim 1, wherein the method of registering interest in an item includes specifying search criteria which will satisfy interest in the item.

11. The method of claim 10, wherein the method of specifying search criteria includes providing item price and/or date by which the item is desired and/or purchasing instructions such as payment instrument, destination address, and/or vendor preferences and/or ratings and/or other such criteria.

12. In a Deal Search process, a method comprising of searching for deals.

13. The method of claim 12, wherein the method of searching for deals includes continuously harvesting deals from deal publishers or item providers.

14. The method of claim 12, wherein the method of searching for deals includes exposing methods for deal publishers or item providers to provide deal data to herein described system.

15. The method of claim 12, where in the method of searching for deals includes soliciting deal information from deal publishers or item providers.

16. The method of claim 12, wherein the method of searching for deals includes exposing methods for users of the system herein to register deals they found with the herein described system.

17. In the Deal Marketplace process, a method comprising of exposing item interests and item search criteria to deal and item providers, soliciting bids for items from deal or item providers, exposing deals to other systems and individuals, and getting counter bids to deals exposed.

18. The method of claim 17, wherein the method of exposing deals includes deal search interface where deals can be found based on specified criteria.

19. The method of claim 17, where in exposing deals includes exposing a continuous stream of deals such that the most current deals can be immediately identified.

20. The method of claim 17, wherein the method of exposing item interests and item search criteria includes search interface where item interests can be found based on specified search criteria.

21. The method of claim 17, where in exposing item interests and item search criteria includes exposing a continuous stream of data such that the most current item interests can be immediately identified.

22. The method of claim 17, where in bidding and counter-bidding for deal includes decreasing price or providing some other compelling elements for a person or system interested in the item to go with the bidder.

23. The method of claim 22, where in bidders can continuously bid against each other to be able to better satisfy the parameters of the item or deal solicited.

24. In an Alert Notification process, a method comprising of registering criteria for an alert, registering alert method and option, and delivering alert.

25. The method of claim 24, where in registering criteria for an alert includes an interface for a user to specify scenarios and criteria under which the alert should be triggered.

26. The method of claim 24, where in registering criteria for an alert to be generated includes a method which provides alert registration interface to other systems or application program interfaces.

27. The method of claim 24, where in delivering alert includes programming instructions that are designed to deliver alert at various times and to various devices, while providing an option to specify when or where not to deliver alerts.

28. The method of claim 25, where in a generated alert allows the user to instruct the system to automatically complete the purchase.
